(19) United States
(12) Patent Application Publication
(10) Pub. No.: US 2010/0139269 A1
(43) Pub. Date: Jun. 10, 2010

(54) TURBOCHARGED INTERNAL COMBUSTION ENGINE AND METHOD

(75) Inventors: Francis Heyes, Lincoln (GB); Norbert Huber, Erlangen (DE); Achim Koch, Tegernheim (DE); Georg Mehne, Wenzenbach (DE); Gerd Rösel, Regensburg (DE); Gerhard Schopp, Pettendorf (DE); Markus Teiner, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Munchen (DE)

(21) Appl. No.: 12/596,158

(22) PCT Filed: Apr. 10, 2008
(86) PCT No.: PCT/EP08/54317

§ 371 Date: Jan. 8, 2010

(30) Foreign Application Priority Data
Apr. 16, 2007 (DE) 10 2007 017 845.1

(51) Int. Cl. F02D 23/00; F01N 3/10; F01N 3/00

(52) U.S. Cl. 60/602; 60/299; 60/287

(57) ABSTRACT

A turbochargeable internal combustion engine contains a motor which has an exhaust manifold on the exhaust gas side, a turbocharger which has at least two turbocharger stages and, on the exhaust gas side, has an exhaust gas inlet and an exhaust gas outlet. The engine further has a primary catalytic converter, which is arranged on the exhaust gas side between the exhaust manifold of the engine block and the exhaust gas inlet of the turbocharger.

The invention relates to a turbochargeable internal combustion engine and to a method for operating such a turbocharged internal combustion engine.

In the case of conventional unsupercharged internal combustion engines (Otto or diesel engines), a vacuum is produced in the intake section when air is drawn in, wherein said vacuum increases with the engine speed and limits the theoretically achievable power of the engine. One way of counteracting this, and hence achieving an increase in power, is to use an exhaust gas turbocharger. An exhaust gas turbocharger (EGT) or turbocharger is a supercharging system for an internal combustion engine, whereby an increased charge-air pressure is applied to the cylinders of the internal combustion engine.

The detailed structure and functionality of such a turbocharger are well known and are therefore explained only briefly below. A turbocharger consists of a turbine (exhaust gas turbine) in the exhaust gas flow (exit flow path), which turbine is connected to a compressor in the intake section (approach flow path) via a shared shaft. The turbine is caused to rotate by the exhaust gas flow of the engine and thus drives the compressor. The compressor increases the pressure in the intake section of the engine, such that a larger quantity of air arrives in the cylinders of the internal combustion engine, due to this compression in the intake section, than in the case of a conventional normally aspirated engine. Consequently, more oxygen is available for combustion. This increases the medium pressure of the engine and its torque, thereby significantly increasing the output power. The supply of a greater quantity of fresh air in connection with the compression process is known as supercharging. The turbine takes the energy for the supercharging from the fast-flowing hot exhaust gases. This energy, which would otherwise be lost by the exhaust system, is utilized to reduce the intake losses. This type of supercharging increases the overall efficiency of a turbocharged internal combustion engine.

For the purpose of reducing exhaust gas emissions, current internal combustion engines feature inter alia catalytic converters which are used for the post-processing of exhaust gases. As a result of using such catalytic converters for exhaust gases, the unavoidable hazardous substances which are generated during the combustion of fuel are converted into less hazardous substances, such that harmful emissions in the exhaust gas can be drastically reduced. The operation of catalytic converters is based on catalytic reactions, in which the harmful hydrocarbon, carbon monoxide and nitrogen oxide contained in the exhaust gas are chemically converted into carbon dioxide, water and nitrogen by means of oxidation and reduction. Depending on the operating point of the engine, and assuming optimal operating conditions, it is possible to achieve conversion rates of almost 100%. The precise structure and functionality of such catalytic converters are generally known, and are therefore not discussed in further detail here.

In the case of conventional, unsupercharged internal combustion engines, the catalytic converter is typically arranged in the exhaust section immediately in front of the tailpipe. In the case of turbocharged internal combustion engines, the exhaust gas outlet side of the internal combustion engine is directly connected to the turbine of the turbocharger, and therefore the catalytic converter is typically located on the exhaust gas side between the turbine outlet and the tailpipe in this case.

When using automobile catalytic converters, the cold running phase of the engine is problematic, i.e. the phase immediately after the engine is started, typically representing a time period of several minutes. The engine and therefore the exhaust gases it produces are still relatively cold during this time period. The problem here is that the catalytic converter should have very high temperatures in the region of at least 250° C. in order to allow high conversion rates. In the cold running phase, however, the exhaust gas produced by the engine is still relatively cold, and therefore the catalytic converter is also very cold as a result. Consequently, the majority of the total harmful emissions of the engine occur during the cold running phase.

As a result of the increasingly rigorous standards for harmful emissions, in particular within the EU and the USA, very low limits are required in respect of these harmful emissions. Future exhaust gas standards, in particular those applying in the USA, will require the limit values for the harmful emissions to be reached already ten seconds after the engine is started. This means that a catalytic converter must already be fully functional at this instant. Therefore the harmful emissions produced during the cold running phase must also be reduced as far as possible. The focus of research today is therefore inter alia on shortening this cold running phase.

The cold running phase can be reduced e.g. if the catalytic converter features a heating device, which is provided specifically for the catalytic converter and heats the catalytic converter when the engine starts. However, the heating of the catalytic converter still requires a certain time, which might not be sufficiently short for future exhaust gas standards in some cases.

A further possibility is to supply more fuel to the engine for a short time (so-called enriched engine cycle), though this involves increased fuel consumption. Here again, the heating up can also take too long in some cases.

A further possibility is to arrange the catalytic converter as close to the engine as possible, e.g. directly behind the exhaust manifold. In the case of turbocharged internal combustion engines, however, it is problematic that the turbocharger is already arranged between the catalytic converter and the exhaust manifold of the internal combustion engine. A further hindrance is that the hot exhaust gases first flow through the turbine of the turbocharger on the exhaust gas side, such that the turbocharger actually draws heat from the exhaust gases, thereby delaying the heating up of the catalytic converter which is arranged after the turbocharger on the exhaust gas side. This problem is particularly acute in the case of multistage turbochargers, in which the hot exhaust gas is guided through a plurality of turbine stages before being supplied to the catalytic converter. The heating of the catalytic converter is delayed still further as a result of this.

Another possibility for rapid heating of the catalytic converter during the cold running phase is to bridge the exhaust gas side of the multistage turbocharger by means of a dedicated bypass pipeline, such that hot exhaust gas produced by the engine is supplied directly to the catalytic converter for the purpose of heating. This solution has the disadvantage that the engine is then no longer supercharged during the cold running phase, i.e. the turbocharger is not initially functional in the cold running phase.

In view of the foregoing, the present invention addresses the problem of reducing to the greatest extent possible the harmful emissions, particularly in the cold running phase, in the case of two-stage turbocharged internal combustion engines.

The invention also addresses the problem of more effectively configuring the purification of the exhaust gas produced by a turbocharged internal combustion engine.

The invention also addresses the problem of additionally or alternatively reducing the fuel in this case.

According to the invention, at least one of the cited problems is solved by a turbocharged internal combustion engine having the features in patent claim 1 and/or by a method having the features in patent claim 16, in which provision is made for the following:
A turbochargeable internal combustion engine which has an engine featuring an exhaust manifold on the exhaust gas side, a turbocharger featuring at least two turbocharger stages and featuring an exhaust gas inlet and an exhaust gas outlet on the exhaust gas side, and a primary catalytic converter that is arranged on the exhaust gas side between the exhaust manifold of the engine block and the exhaust gas inlet of the turbocharger.
A method for operating a turbocharged internal combustion engine as per the invention, comprising a first operating mode in which the exhaust gases produced by the engine are initially guided via the primary catalytic converter, and a second operating mode in which the primary catalytic converter is bridged and the exhaust gases produced by the engine are guided via a main catalytic converter which is arranged after the primary catalytic converter on the exhaust gas side.

The idea which forms the basis of the present invention consists of arranging an (additional) catalytic converter directly at the exhaust gas outlet of the engine, i.e. between this exhaust gas outlet and the turbine inlet of the turbocharger, in the case of a two-stage turbocharger. This catalytic converter typically functions here as an auxiliary catalytic converter to a main catalytic converter which is typically provided already and is arranged e.g. immediately in front of the tailpipe on the exhaust gas side. This catalytic converter is therefore arranged in the region of the exhaust gas section at the position where the exhaust gases produced by the engine are at their hottest.

During the cold running phase of the engine, the auxiliary catalytic converter is therefore heated first by the hot exhaust gases. Only then are these exhaust gases guided to the high-pressure turbine of the turbocharger. In particular, the cold running phase of the engine can be shortened by means of the inventive auxiliary catalytic converter, thereby making it possible to satisfy the very strict exhaust gas standards required in the future, particularly in the EU and in the USA.

The provision of a further catalytic converter does represent an addition overhead and hence additional cost. However, considerable fuel can be saved by using an auxiliary catalytic converter in the cold running phase, and therefore the additional cost of providing the auxiliary catalytic converter can be balanced out by the fuel savings in the medium term.

According to the invention, the auxiliary catalytic converter therefore operates primarily in the cold running phase, while the actual catalytic converter, i.e. the catalytic converter which is arranged on the tailpipe side, is intended for the normal operation of the internal combustion engine. This actual catalytic converter no longer has to be optimized for the cold running phase, and therefore it can also be built more ruggedly, this being advantageous particularly in terms of service life. Conversely, the auxiliary catalytic converter can be optimized for just the cold running phase, which likewise has an advantageous effect on its service life.

Advantageous embodiments and developments of the invention are derived from the further subclaims and from the description in conjunction with the drawing.

In a typical embodiment, the turbocharged internal combustion engine features an exhaust gas outlet system, which is arranged on the exhaust gas side between the exhaust gas outlet of the turbocharger and an exhaust gas outlet of the turbocharged internal combustion engine. This exhaust gas outlet system, which is also known as a tailpipe system and therefore features the tailpipe, inventively features a main catalytic converter. This main catalytic converter, which is provided in addition to the primary catalytic converter, is likewise used to reduce exhaust gas emissions that are generated during the combustion of fuel.

The main catalytic converter is typically, but not necessarily, configured for a greater throughput of exhaust gas than the primary catalytic converter. In comparison with previously known solutions that do not include a primary catalytic converter, the invention now provides for this main catalytic converter to be supplied with exhaust gas air that already very hot when an engine is started, and therefore this main catalytic converter no longer has to be optimized and configured for low temperatures, but can be configured for an optimal exhaust gas conversion temperature. As a result of this, the efficiency of the main catalytic converter increases further, whereby the exhaust gas emissions can be significantly reduced accordingly.

In a preferred embodiment, the auxiliary catalytic converter is designed so as to be significantly smaller than the actual catalytic converter. This is because a smaller exhaust gas throughput is typically present in the cold running phase, and the catalytic converter requires a smaller (effective) diameter and hence a smaller active catalytic converter area accordingly.

In preferred embodiment, provision is made for a first bypass device, which is used to bridge the primary catalytic converter. This first bypass device is configured, in an open state, to guide the exhaust gas that is produced by the engine block past the primary catalytic converter. The provision of such a first bypass device is advantageous if the primary catalytic converter is designed to be smaller than the main catalytic converter and is therefore only configured for small quantities of exhaust gas. This small primary catalytic converter is therefore only configured for the cold running phase of the engine, i.e. the time period immediately after the engine is started. After this period, when higher exhaust gas throughputs are present at higher temperatures, it is bridged by the first bypass device. As a result, the auxiliary catalytic converter is protected from excessive exhaust gas throughputs and hence rapid aging.

For this purpose, the first bypass device is preferably designed such that it can be controlled, and therefore features a controllable bypass switch. In a typical embodiment, this bypass switch can feature a bypass valve, a bypass pipe switch, a bypass flap or similar. A combination of these elements would also be conceivable.

In preferred embodiment, a first pipeline is provided for connecting the exhaust manifold to an inlet of the primary catalytic converter, and a second pipeline is provided for connecting an outlet of the primary catalytic converter to the exhaust gas inlet of the turbocharger. Furthermore, at least one bypass pipeline is provided as a component of this bypass device, wherein said bypass pipeline branches off from the first pipeline via a first pipe branch point and leads into the second pipeline via a second pipe branch point.

In preferred embodiment, provision is made for a first measuring device, which measures the temperature of the exhaust gas flow, in particular in a region of an exhaust gas outlet system of the turbocharged internal combustion engine. Additionally or alternatively, the temperature of the exhaust gas flow can also be measured at any other place in the exhaust gas section of the turbocharged internal combustion engine.

In a further and likewise advantageous embodiment, provision is made for a second measuring device, which determines the air throughput in a fresh-air section of the internal combustion engine. This measured air mass flow (AMF) indicates the throughput of air through a compressor.

Additionally or alternatively, provision can also be made for an analysis device which determines the temperature of the exhaust gas flow in the region of the exhaust gas outlet system of the internal combustion engine, and the air throughput in a fresh-air section of the internal combustion engine, on the basis of known engine characteristic values and current engine parameters, using a known engine characteristic curve which is stored in the analysis device. Determining the air throughput and temperature is advantageously done here on the basis of known relationships of the functionality of the internal combustion engine, and therefore does not require separate measurements to be taken.

In preferred embodiment, provision is made for a control device which controls at least one of the bypass devices of the turbocharged internal combustion engine. In a particularly preferred embodiment, this control device is configured to control the function of the bypass switch of the first bypass device. In this case, the control of the bypass switch takes place in accordance with the measured or determined temperature and/or the measured or determined air throughput in particular. This control unit is preferably also configured such that it controls a second bypass device for bridging a compressor wheel and/or a third bypass device for bridging a turbine wheel.

The control device can also be part of the turbocharger or the internal combustion engine, for example. However, the control device or analysis device is preferably designed as part of the engine control unit for controlling both the internal combustion engine and the turbocharger. In this case, the control device can feature e.g. a program-controlled unit such as a microcontroller or microprocessor, for example. The control device can control the relevant bypass device mechanically or electrically. If the bypass devices are electrically activated, they can feature e.g. an electrically controllable actuator.

In a preferred embodiment, the turbocharger features a high-pressure stage and a low-pressure stage. The high-pressure stage contains a high-pressure turbine and a high-pressure compressor which are coupled together via a shared shaft. The low-pressure stage features a low-pressure turbine and a low-pressure compressor.

In a further preferred embodiment, provision is made for a second bypass device for bridging at least one compressor, and in particular at least the high-pressure compressor here. In this way, the fresh air is at least partially guided past the compressor and e.g. supplied directly to the engine in uncompressed form. In this way, it is possible to prevent or at least limit an excessive pressure difference between the inlet side of the compressor and its outlet side. Consequently, there is no excessive vacuum on the outlet side of the compressor relative to its inlet side, thereby also ensuring that the engine is not choked as a result. The particular advantage is that, by virtue of the inventive second bypass device, it is possible to largely avoid or at least significantly reduce a turbohole which typically occurs at low rotational speeds of the turbocharger. This operation of the turbocharger is advantageous in particular at low rotational speeds of the turbocharger and therefore when accelerating from low rotational speeds.

In a likewise typical embodiment, the inventive turbocharger features a third bypass device, which is configured for bridging at least one turbine and in particular the high-pressure turbine in this context. This further bypass device, which is frequently also referred to as a waste gate, is used for the boost pressure control. The waste gate can feature a bypass valve, a flap or a bypass pipe switch, for example. This bypass valve usually bridges the turbine on the exhaust gas side by means of a dedicated pipeline. At a selected boost pressure, this bypass valve is opened by a transducer on the compressor side, and then guides the exhaust gas via the bypass pipeline and the bypass valve past the turbine and directly into the tailpipe, thereby preventing a further increase in the rotational speed of the turbine. In this way, it is possible to prevent the turbine and hence also the compressor of the turbocharger from rotating ever faster, and to prevent the compressor from reaching its operating limit due to a positive feedback of turbine rotation and compressor rotation, and to prevent the mechanical and thermal limits of the engine from being exceeded and possibly resulting in destruction of the turbocharger and of the engine.

In preferred embodiment of the inventive method, the exhaust gases that have been pre-purified in the primary catalytic converter and/or the unpurified exhaust gases are also supplied to the main catalytic converter in the first operating mode.

In preferred embodiment, the temperature of the exhaust gases is measured and/or determined from a known engine characteristic curve and known engine parameters. Provision is preferably made for specifying a temperature threshold in this case, wherein the primary catalytic converter and the main catalytic converter are operated in the first operating mode if the determined temperature is below the predefined temperature threshold, and the primary catalytic converter and main catalytic converter are operated in the second operating mode if the determined temperature is above the predefined temperature threshold.

In preferred embodiment, the turbocharged internal combustion engine is initially operated in the first operating mode immediately after the engine is started and then, once the main catalytic converter has a predefined temperature, in the second operating mode.

The invention is explained in greater detail below, with reference to the exemplary embodiments that are shown in the figures of the drawings, in which:

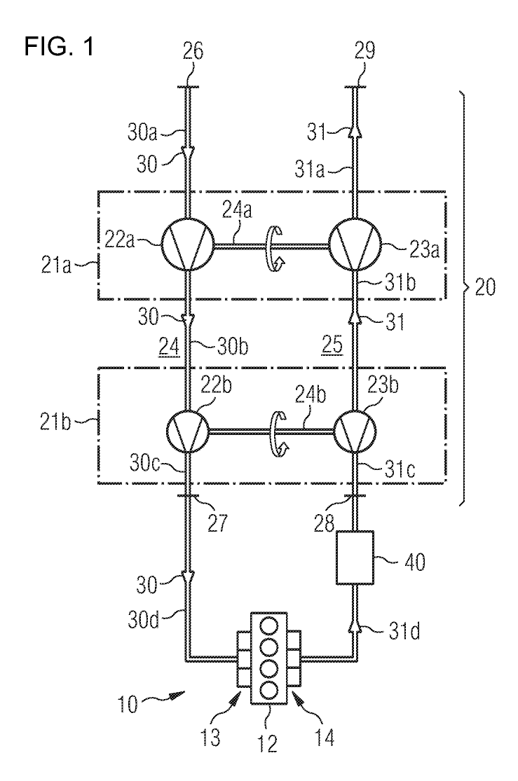

FIG. 1 shows a schematic illustration of a general first exemplary embodiment of a turbocharged internal combustion engine according to the invention;

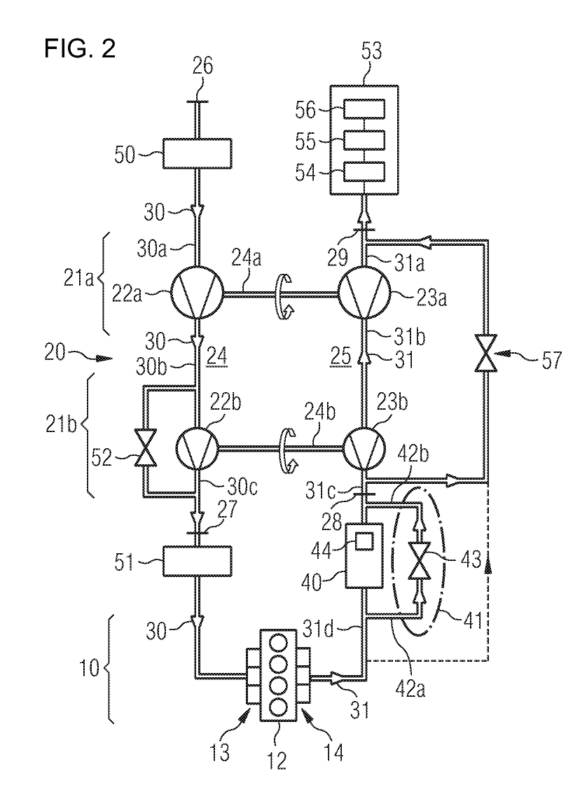

FIG. 2 shows a schematic illustration of a second exemplary embodiment of a turbocharged internal combustion engine according to the invention;

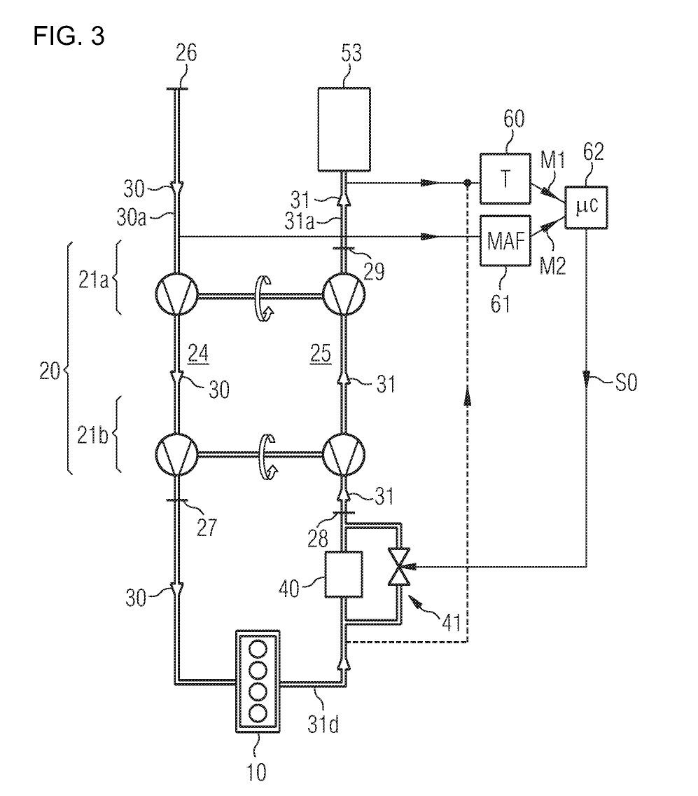

FIG. 3 shows a schematic illustration of a third exemplary embodiment of a turbocharged internal combustion engine according to the invention;

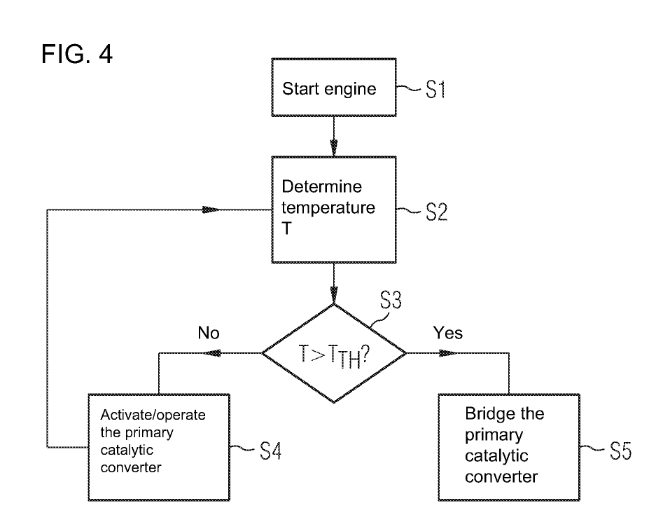

FIG. 4 shows a flow diagram to illustrate a method according to the invention for operating the turbocharged internal combustion engine according to the invention.

In the figures of the drawings, identical and functionally identical elements, features and variables are designated by the same reference signs unless otherwise specified.

FIG. 1 shows a schematic illustration of a first general exemplary embodiment of a highly simplified turbocharged internal combustion engine according to the invention, in which only the essential components are illustrated.

The turbocharged internal combustion engine 10 (having reference sign 10), e.g. an Otto or diesel engine, has an engine block 12 which contains four cylinders in the illustrated example, it being understood that this is merely exemplary. In a known manner, the internal combustion engine 10 additionally features an intake manifold 13 and an exhaust manifold 14, which are likewise illustrated in FIG. 1 in a merely schematic and highly simplified manner. The intake manifold 13 therefore forms the air inlet side of the engine block and the exhaust manifold 14 forms its exhaust gas outlet side.

The internal combustion engine 10 also features a turbocharger 20. The turbocharger 20, which is coupled with the internal combustion engine 10, is designed to comprise two stages, i.e. the turbocharger 20 features two turbocharger stages 21a, 21b. Each of the turbocharger stages 21a, 21b features a dedicated compressor 22a, 22b and a dedicated turbine 23a, 23b, these being mechanically coupled via a shared shaft 24a, 24b within the respective turbocharger stages 21a, 21b. In this case, the first turbocharger stage 21a is designed as a low-pressure stage 21a and comprises a low-pressure compressor 22a and a low-pressure turbine 23a. The second turbocharger stage 21b is designed as a high-pressure stage 21b and therefore comprises a high-pressure compressor 22b and a high-pressure turbine 23b.

The turbocharger 20 features an approach flow path 24 and an exit flow path 25. The approach flow path 24 of the turbocharger 20 is defined between a fresh-air inlet 26, via which the fresh air is inducted, and a fresh-air outlet 27, via which the fresh air that has been compressed by the compressor 22a, 22b is provided by the turbocharger 20. This compressed fresh air is supplied to the engine 12 via the fresh-air outlet 27 of the fresh-air inlet side 13. The exit flow path 25 of the turbocharger 10 is defined between an exhaust gas inlet 28, via which exhaust gas that has been generated by the engine 12 is introduced into the turbocharger 10, and an exhaust gas outlet 29, via which the exhaust gas can flow out. The approach flow path 24 is frequently also referred to as the intake section, fresh-air side, compressor side or charge-air side, while the exit flow path 25 is frequently also referred to as the exhaust gas section, exhaust gas path, turbine side or exhaust gas side.

With regard to the terminology selected in the present patent application, a relevant compressor 22a, 22b and a relevant turbine 23a, 23b feature an inlet on the input side and an outlet on the output side for the fresh air or exhaust gas respectively. The flow direction on the compressor side is determined by the airflow of the fresh air, i.e. towards the engine 12. The flow direction on the turbine side is determined in each case by the airflow of the exhaust gas, i.e. away from the engine 12. In all the figures, the flow directions of the fresh air and the exhaust gas are represented by corresponding arrows. The fresh-air flow is designated by the reference sign 30 and the exhaust gas flow is designated by the reference sign 31 here.

Provision is made for a first pipeline 30a between the fresh-air inlet 26 and the inlet of the low-pressure compressor 22a, for a second pipeline 30b between the outlet of the low-pressure compressor 22a and the inlet of the high-pressure compressor 22b, and for a third pipeline 30c within the turbocharger 20 on its approach flow side 24 between the outlet of the high-pressure compressor 22b and the fresh-air outlet 27. Provision is similarly made for a first pipeline 31c between the exhaust gas inlet 28 and the high-pressure turbine 23b, for a second pipeline 31b between the outlet of the high-pressure turbine 23b and the inlet of the low-pressure turbine 23a, and for a third pipeline 31a within the turbocharger 20 on its exit flow side 25 between the outlet of the low-pressure turbine 23a and the exhaust gas outlet 29. Even though reference is made here to pipelines 30a-30c, 31a-31c within the turbine, it is understood that said references obviously relate to channels within the housing of the turbocharger.

The two turbines 23a, 23b are driven by the exhaust gas flow 31 which is supplied to them via the pipelines 31c, 31b, whereby the corresponding compressors 22a, 22b are also driven by virtue of the mechanical coupling of these turbines 23a, 23b by means of the shafts 24a, 24b. The compressors 22a, 22b are then able to compress the fresh air 30, which is supplied to them via the pipelines 30a, 30b, and supply it to the engine 12.

A further pipeline 30d is provided for coupling the turbocharger 20 to the engine 12 on the fresh-air side, and a further pipeline 31d is arranged between the turbocharger 20 and the engine 12 for the coupling on the exhaust gas side.

According to the invention, provision is now made for a primary catalytic converter 40 on the exhaust gas side 25. The primary catalytic converter 40 is arranged in the pipeline 31d between the exhaust manifold 14 of the engine 12 and the exhaust gas inlet 28 of the turbocharger 20. The primary catalytic converter 40 is preferably connected directly to the exhaust manifold 14, such that the primary catalytic converter 40 is supplied with the hottest possible exhaust gas 31. When the engine is started, the primary catalytic converter 40 is therefore supplied directly with exhaust gas 31, i.e. without the exhaust gas 31 passing through the turbocharger 20 first, and the primary catalytic converter 40 is therefore heated up very quickly. The exact functionality of this primary catalytic converter 40 is described in detail below.

FIG. 2 shows a second exemplary embodiment of a turbocharged internal combustion engine according to the invention. The primary catalytic converter 44 preferably features an integrated lambda sonde 44. Using this lambda sonde 44 in conjunction with a three-way catalytic converter, for example, the combustion in the engine 12 can be optimized relative to the exhaust gas emissions that are produced in this case, thereby allowing the exhaust gas emissions to be regulated.

In FIG. 2, an air filter 50 is provided in the first pipeline 30a and is used to purify the air that is sucked in, thereby preventing minute particles of dust and other particles from reaching the compressor wheel, which operates at very high rotational speeds, and possibly resulting in damage or even destruction of the compressor wheel.

Provision is also made for a charge-air cooler 51 in the pipeline 30d. The charge-air cooler is used to re-cool the compressed charge air which is supplied to the internal combustion engine, wherein said air becomes very hot at very high rotational speeds of the turbocharger and can therefore reduce the power of the internal combustion engine in some circumstances, such that optimal combustion can occur in the engine block 31.

In addition, provision is preferably made for a controllable bypass device 52 in the approach flow path 26. This bypass device 52 can feature e.g. a bypass valve, a bypass flap, a bypass pipe switch or similar. The bypass device 52 in the example shown in FIG. 2 is configured to bridge the high-pressure compressor 22b. For this purpose, a bypass pipeline branches off from the pipeline 31c, such that the fresh air is guided past the high-pressure compressor 22b when the bypass switch is open, and then leads into the pipeline 30c.

Although the bypass device 52 in FIG. 2 only bridges the high-pressure compressor 22b, it is also conceivable to configure said bypass device 52 to bridge both compressors 22a, 22b simultaneously, only the low-pressure compressor 22a, or indeed either the high-pressure or the low-pressure compressor 22a, 22b.

In the exit flow path 25, provision is further made for a bypass device 57, which is also referred to as a waste gate.

This bypass device 57 is used to guide exhaust gas past both turbines 23a, 23b, thereby preventing the two turbines 23a, 23b from reaching excessive rotational speeds and hence, due to the coupling of these turbines with the relevant compressors 22a, 22b, preventing the engine from exceeding its power limit as a result of being supplied with too much oxygen via the over-compressed fresh air 30.

Additionally or alternatively (broken marked in FIG. 2), the bypass device 57 can also be configured to bridge both the primary catalytic converter 40 and the two turbines 23a, 23b.

On the exit flow side 25, provision is further made for an exhaust gas outlet system 53, which is connected to the exhaust gas outlet 29 via corresponding pipelines. In a manner which is known, the exhaust gas outlet system comprises e.g. a (main) catalytic converter 54, an exhaust gas filter 55, and a tailpipe 56 which is arranged beyond these.

In addition, provision is made for a further bypass device 41. The further bypass device 41 is configured to bridge the primary catalytic converter 40 by means of corresponding bypass pipelines 42a, 42b. This further bypass device 41 is typically designed such that it can be controlled and, for this purpose, comprises e.g. a controllable valve (or flap or choke) which can be controlled to be in an open or closed state accordingly. In the closed state, the exhaust gas therefore flows exclusively via the primary catalytic converter 40, whereas in the open state of this bypass valve 43, the exhaust gas—due to the flow resistance which is provided by the primary catalytic converter 40—flows (to a greater or lesser extent) via the bypass device 41 and past the primary catalytic converter 40.

FIG. 3 shows a third, greatly simplified exemplary embodiment of a turbocharged internal combustion engine according to the invention. The arrangement in FIG. 3 comprises two measuring devices 60, 61. The first measuring device 60 is configured to measure the temperature T of the exhaust gas flow 31, e.g. immediately in front of the main catalytic converter 54. For this purpose, the first measuring device 60 is connected on the input side to the pipeline 31a which leads into the catalytic converter 54. Additionally or alternatively, it would also be conceivable (broken line in FIG. 3) for the first measuring device 60 to measure the temperature of the exhaust gas flow 31 immediately at the exhaust manifold 14. Depending on the temperature T determined thus, the first measuring device 60 generates a measurement signal M1.

The second measuring device 61 is configured to determine the air throughput on the approach flow side 24. For this purpose, the second measuring device 61 is connected to the pipeline 30a on the input side, in order to measure the mass air flow (MAF=Mass Air Flow) in this pipeline 30a. Depending on the mass air flow determined thus, the second measuring device 61 generates a measurement signal M2.

In addition, the arrangement in FIG. 3 features a control device 62 which can be a component of the turbocharger 20 or the internal combustion engine 10, or can also be designed as a separate control device 62, e.g. as a component of the engine control unit. The control device 62 is designed to control at least the controllable bypass device 41 in accordance with a control signal S0. This control signal S0 is generated in accordance with at least one of the two measurement signals M1, M2. Depending on these measurement signals M1, M2, the control signal S0 controls the bypass device 41 such that is in an open or a closed state, thereby controlling the function of the primary catalytic converter 40 to the effect that exhaust gas 31 which is generated by the engine 12 flows either directly via the primary catalytic converter 40 or via the bypass device 41. Additionally or alternatively, the control device 62 also controls the function of the further bypass devices 52, 57.

In addition to directly determining this measurement data M1, M2, which is used for activating the bypass device 41, this measurement data can also be determined by the engine control unit 62 itself. For example, during the operation of an internal combustion engine, the engine control unit 62 identifies the corresponding engine load and can deduce the temperature T and the air throughput AMF therefrom by means of integral generation of the effective medium pressure of the engine 12. The temperature can be determined without direct measurement in this way.

A preferred method for operating the inventive turbocharged internal combustion engine is described below with reference to the flow diagram in FIG. 4. The following process steps correspond to the corresponding reference signs used in FIG. 4 in this case.
S1: The engine is started in the first step.
S2: Immediately after the engine is started, the temperature T of the exhaust gas is determined on the exit flow side 25 and in particular directly in the exhaust manifold 14. The temperature T can be determined by means of direct measurement using a dedicated measuring device 60. In addition, this temperature T can also be calculated by the engine control unit itself.
S3: Provision is then made for checking whether the temperature T thus determined is sufficiently high, i.e. whether the temperature is higher or lower than a predefined temperature threshold T_{TH}. This temperature threshold T_{TH} is selected such that, at this temperature, the main catalytic converter 54 is heated to a specified operating temperature within a predefined time period. This time period is specified on the basis of gas emission standards, for example. These standards state, inter alia, that the main catalytic converter must have a predefined operating temperature within a defined time in order to achieve operational functionality.
S4: If the temperature T of the exhaust gas is lower than the predefined temperature threshold T_{TH}, the primary catalytic converter 40 is then activated by closing the bypass device 41. Consequently, exhaust gas that is generated by the internal combustion engine 30 initially flows exclusively via the primary catalytic converter 40. This primary catalytic converter 40 is typically much smaller in design that the main catalytic converter 54 and, as a result of this and as a result of the fact that the heated air is supplied directly and immediately to the primary catalytic converter 40, heats up very quickly. The cold running phase is significantly shortened in this way. The exhaust gas which is purified thus in the primary catalytic converter 40 can then be guided either via the turbines 23b, 23a or, depending on the operation, past these turbines 23a, 23b and directly to the main catalytic converter 54 via the waste gate bypass 57. The latter measure would ensure that the turbines 23a, 23b do not extract any further energy from the still relatively hot exhaust gas 31, such that the main catalytic converter 54 is heated up even more quickly in this way.
S5: While the bypass device 41 is closed, the temperature is continuously determined and compared with the predefined temperature threshold T_{TH}. If the determined temperature T is higher than the predefined temperature threshold T_{TH}, the bypass device 41 is opened, such that the exhaust gas no longer flows via the primary catalytic converter 40, but either directly via the turbines 23a, 23b or via the waste gate bypass 57 directly into the main catalytic converter 54. This main catalytic converter 54 is now intended exclusively to purify the exhaust gas 31 that is supplied to it.
   However, since the main catalytic converter 54 was already heated previously to a greater or lesser degree by the exhaust gas 54 that was supplied to it, it is already at its operating temperature, at which correct purification of the gas emissions is possible. Failing this, the main catalytic converter 54 will at least heat up to this operating temperature very quickly.

The present invention is not limited to the above exemplary embodiments, but can obviously be modified in manifold ways.

1-20. (canceled)

21. A turbocharged internal combustion engine, comprising:
an engine having an exhaust manifold on an exhaust gas side;
a turbocharger having at least two turbocharger stages, an exhaust gas inlet and an exhaust gas outlet on said exhaust gas side; and
a primary catalytic converter disposed on the exhaust gas side between said exhaust manifold of said engine and said exhaust gas inlet of said turbocharger.

22. The turbocharged internal combustion engine according to claim 21, further comprising:
an exhaust gas outlet; and
an exhaust gas outlet system disposed on said exhaust gas side between said exhaust gas outlet of said turbocharger and said exhaust gas outlet of the turbocharged internal combustion engine, said exhaust gas outlet system having a main catalytic converter for reducing exhaust gas emissions generated during combustion of fuel in said engine.

23. The turbocharged internal combustion engine according to claim 22, wherein said main catalytic converter is configured for a higher throughput of the exhaust gas than said primary catalytic converter.

24. The turbocharged internal combustion engine according to claim 22, wherein said primary catalytic converter has an active catalytic converter surface being smaller than an active catalytic converter surface of said main catalytic converter.

25. The turbocharged internal combustion engine according to claim 22, further comprising a first bypass device for bridging said primary catalytic converter, said first bypass device being configured to guide the exhaust gas produced by said engine past said primary catalytic converter when in an open state.

26. The turbocharged internal combustion engine according to claim 25, wherein said first bypass device has a controllable bypass switch.

27. The turbocharged internal combustion engine according to claim 25, further comprising:
a first pipeline connecting said exhaust manifold to an inlet of said primary catalytic converter;
a second pipeline connecting an outlet of said primary catalytic converter to said exhaust gas inlet of said turbocharger; and
at least one bypass pipeline being a component of said first bypass device, said bypass pipeline branches off from said first pipeline via a first pipe branch point and leads into said second pipeline via a second pipe branch point.

28. The turbocharged internal combustion engine according to claim 22, further comprising a first measuring device for determining a temperature of an exhaust gas flow in a region of said exhaust gas outlet system of the turbocharged internal combustion engine.

29. The turbocharged internal combustion engine according to claim 28, further comprising a second measuring device for determining an air throughput in a fresh-air section of the turbocharged internal combustion engine.

30. The turbocharged internal combustion engine according to claim 26, further comprising an analysis device for determining a temperature of an exhaust gas flow in a region of said exhaust gas outlet system of the turbocharged internal combustion engine, and an air throughput in a fresh-air section of the internal combustion engine, on a basis of known engine characteristic values and current engine parameters, using a known engine characteristic curve stored in said analysis device.

31. The turbocharged internal combustion engine according to claim 30, further comprising a control device for controlling said bypass device.

32. The turbocharged internal combustion engine according to claim 31, wherein said control device controls a function of said bypass switch.

33. The turbocharged internal combustion engine according to claim 31, wherein at least one of said control device and said analysis device are components of an engine control unit.

34. The turbocharged internal combustion engine according to claim 21, wherein one of said turbocharger stages is a high-pressure stage having a high-pressure turbine and a high-pressure compressor, and another of said turbocharger stages is a low-pressure stage having a low-pressure turbine and a low-pressure compressor.

35. The turbocharged internal combustion engine according to claim 34, further comprising:
a second bypass device for bridging at least one of said high-pressure compressor and said low-pressure compressor; and
a third bypass device for bridging at least one of said high-pressure turbine and said low-pressure turbine.

36. The turbocharged internal combustion engine according to claim 26, wherein said controllable bypass switch is one of a bypass valve, a bypass pipe switch and a bypass flap.

37. The turbocharged internal combustion engine according to claim 32, wherein said control device controls at least one of a temperature and an air throughput that has been determined.

38. The turbocharged internal combustion engine according to claim 35, wherein:
said second bypass device bridges said high-pressure compressor; and
said third bypass device bridges said high-pressure turbine.

39. A method for operating a turbocharged internal combustion engine containing an engine having an exhaust manifold on an exhaust gas side, a turbocharger having at least two turbocharger stages, an exhaust gas inlet and an exhaust gas outlet on the exhaust gas side, and a primary catalytic converter disposed on the exhaust gas side between the exhaust manifold of the engine and the exhaust gas inlet of the turbocharger, which further comprises:
during a first operating mode, initially guiding exhaust gases produced by the engine via the primary catalytic converter; and
during a second operating mode, in which the primary catalytic converter is bridged, guiding the exhaust gases produced by the engine via a main catalytic converter disposed after the primary catalytic converter on the exhaust gas side.

40. The method according to claim 39, which further comprises supplying at least one of the exhaust gases that have been pre-purified in the primary catalytic converter and unpurified exhaust gases to the main catalytic converter in the first operating mode.

41. The method according to claim 39, which further comprises at least one of measuring and determining a temperature of the exhaust gases from a known engine characteristic curve and known engine parameters.

42. The method according to claim 41, which further comprises:
predefining a predefined temperature threshold; and
operating the primary catalytic converter and the main catalytic converter in the first operating mode if the temperature determined is lower than the predefined temperature threshold; and
operating the primary catalytic converter and main catalytic converter in the second operating mode if the temperature determined is higher than the predefined temperature threshold.

43. The method according to claim 39, which further comprises:
initially operating the turbocharged internal combustion engine in the first operating mode immediately after the engine is started; and
subsequently operating the turbocharged internal combustion engine in the second operating mode when the main catalytic converter has a predefined temperature.
